(19) United States
(12) Patent Application Publication
(10) Pub. No.: US 2018/0067907 A1
(43) Pub. Date: Mar. 8, 2018

(54) DOCUMENT MANAGEMENT SYSTEM

(71) Applicant: Theodor Holm Nelson, Sausalito, CA (US)

(72) Inventor: Theodor Holm Nelson, Sausalito, CA (US)

(21) Appl. No.: 15/697,435

(22) Filed: Sep. 6, 2017

Related U.S. Application Data
(60) Provisional application No. 62/383,603, filed on Sep. 6, 2016.

(51) Int. Cl. G06F 17/22; G06F 17/30; G06Q 20/12

(52) U.S. Cl. CPC G06F 17/2235; G06F 17/30011; G06F 3/0482; G06F 17/2247; G06Q 20/123

(57) ABSTRACT

A method for document management by a user of a computerized system including a display screen. A document is provided that appears as plain text on the display screen. Within the document is a connection wherein, when non-activated, the connection appears as the plain text on the display screen. And the connection, when activated by the user of the computerized system, the connection is thereby activated and connection then appears on the display screen as the plain text along with an open visible bridge that connects to an open other content.

### CROSS-REFERENCE TO RELATED APPLICATIONS

Not applicable. This application claims the benefit of U.S. Provisional Application No. 62/383,603, filed Sep. 6, 2016, hereby incorporated by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### COPYRIGHT NOTICE AND PERMISSION

This document contains some material which is subject to copyright protection. The copyright owner has no objection to the reproduction with proper attribution of authorship and ownership and without alteration by anyone of this material as it appears in the files or records of the Patent and Trademark Office, but otherwise reserves all rights whatsoever.

### BACKGROUND OF THE INVENTION

### Technical Field

The present invention relates generally to data processing, and more particularly to an operator interface with which a user can manage documents.

### Background Art

Document processing systems are, generally, known art. By in large, however, such systems work with a single document at a time, whereas the real nature of our work with documents often entails working with many documents at once, perhaps related, e.g., by quotation, critique, version, generation, etc. What is sorely needed is an improved document management system that permits us manage such document projects.

### BRIEF SUMMARY OF THE INVENTION

It is an object of the present invention to provide an improved document management system.

Briefly, one preferred embodiment of the present invention is a method for document management by a user of a computerized system including a display screen. A document is provided that appears as plain text on the display screen. Within the document a connection is provided that, when non-activated, appears as said plain text on the display screen. However, when the connection is activated, by selection by the user of the computerized system, the connection then appears on the display screen as the plain text along with an open visible bridge that connects to an open other content.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIG. 1 shows an example of a xanadoc;

FIG. 2 depicts an activated xanalink, from the xanadoc to a portion of a historical document (other content);

FIG. 3 depicts an activated xanalink, from the xanadoc to a portion of a scientific document (other content);

FIG. 4 depicts an activated xanalink, from the xanadoc to a portion of a topical document (other content);

FIG. 5 depicts the xanalinks to both the historical and scientific documents activated, to illustrate that multiple xanalinks and instances of other content can be worked with concurrently;

FIG. 6 shows how the xanadoc appears to a reader before a transclusion in it is activated;

FIG. 7 shows what happens when the transclusion 16 is activated and a visible bridge and the other content appear;

FIG. 8 shows the content of an edit decision list (ED);

FIG. 9 shows some, here all, of the list content being selected and copied;

FIG. 10 shows the copied list content being pasted into a viewer;

FIG. 11 shows how the resulting xanadoc appears in a xanaviewer;

FIG. 12 stylistically shows a block portion that appears if we scroll down below what we previously viewed in the xanadoc;

FIG. 13 shows the example of FIG. 12 with the transclusions there resolved into usable spans;

FIG. 14 shows a sample xanadoc in the xanaviewer as an EDL;

FIG. 15 shows the editing window for EDLs in the xanaviewer, which is suitable for viewing and editing the xanadoc;

FIG. 16 shows a sample span selector, to select and measure spans.

FIG. 17 shows modifying a sample xanadoc;

FIG. 18 shows an example of modifying a sample xanalink; and

FIG. 19 shows an EDL with extensive comments.

In the various figures of the drawings, like references are used to denote like or similar elements or steps.

### DETAILED DESCRIPTION OF THE INVENTION

A preferred embodiment of the present invention is a document management system as illustrated in the various drawings herein, wherein the embodiment(s) of the invention are depicted by the general reference character 10.

The present invention is a system which the inventor has been working on a long time, a system with a principal that most people have not readily understood—with visible connections between document pages, with every quotation connected to its source, and concurrently a copyright system that allows the mixing of free and paid content.

Why have people not understood the principal here? Because it is too many concepts at once, even though they condense into one simple unified idea. People seem to confuse this new system with the World Wide Web, but it was effectively a fork of this project made long ago. Today we see PDF and .doc formats, competing for a new kind of document which one can write, distribute and connect directly, without jumps into unknown hyperspace.

Why have people not been able to use a system based on this principal? Well, there have been lots of prototypes, but there has not been a working system that anyone could use with their own new documents until now. The inventor now discloses a system that one can open and use. The embodiment disclosed here does not include a good editor, yet, but editors are straightforward and known technology. With a little determination and a grasp of the principal disclosed here one skilled in the art can make a “xanadoc” on their own and send it out to people, and they can view it in a browser.

Various points of novelty that will be covered here. One such point is the sale of content (e.g., documents, media, etc.) by small “grains” (e.g., by the character, image, chord, etc.), including managing such sales with a royalty server. Another point is the mixing of free and paid content. And another such point is the delivery of a document as a list that permits a computerized machine to send for, process, and fulfill the document as a new manner of presentation on a display screen.

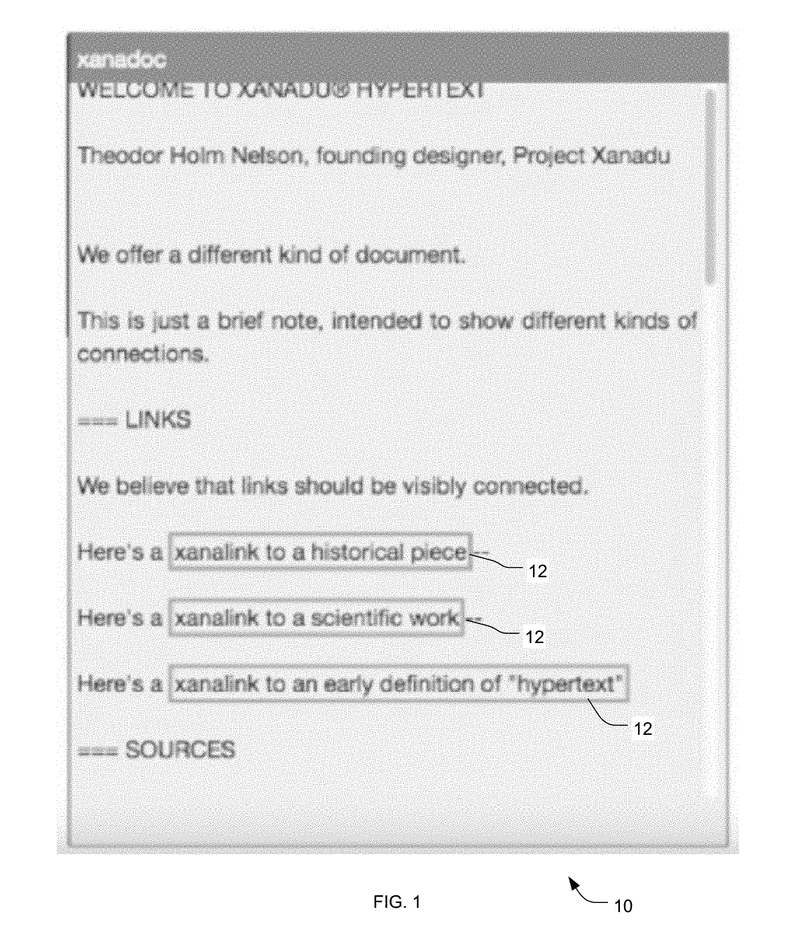

FIG. 1 shows an example of a “xanadoc” (xanadoc 10). Right now it appears as plain text. But if we want to see connections, they are here as “xanalinks” (xanalinks 12) (stylistically shown in the black and white figures as outlining boxes).

These xanalinks 12 are not just jump-links, however, which other people often term hyperlinks today. With hyperlinks, or jump-links as the inventor has called these since before the Web existed, one jumps to where one knows not. They are diving boards into darkness. In contrast, when activated, a xanalink 12 opens a visible bridge that connects to other content (e.g., another document).

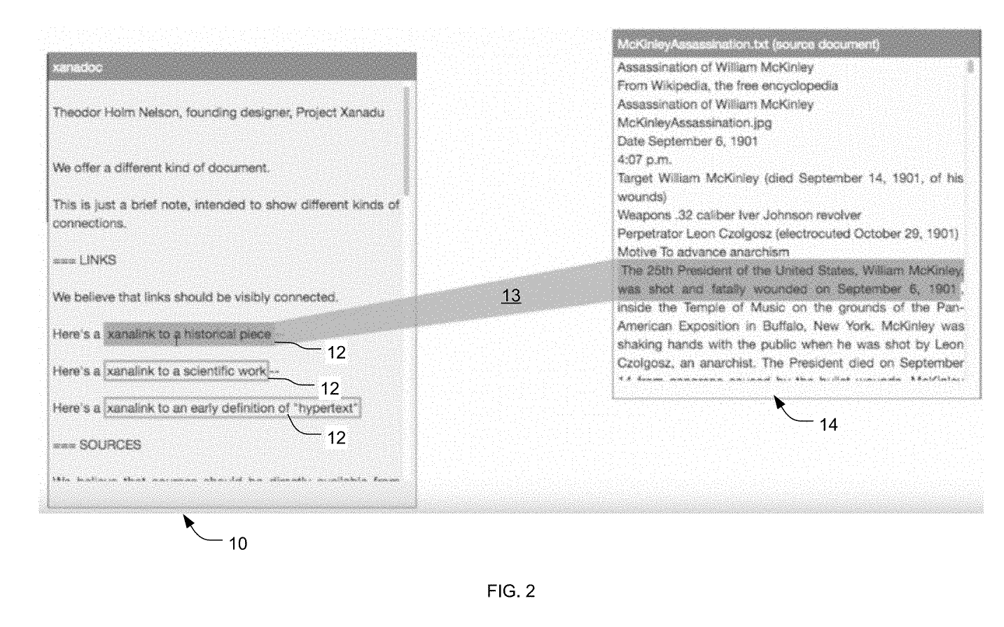

FIGS. 2-5 show examples of how the xanadoc 10 in FIG. 1, with the xanalinks 12 there, open visible bridges 13 that connect to other content 14. The xanalinks 12 here are each linkages, shown as the visible bridges 13, to instances of the other content 14 which here are each other documents. Such an other content 14 is opened when a xanalink 12 is clicked, and can be closed again by clicking the xanalink 12 again. Additionally, once a xanalink 12 is activated, the other content 14 that appears can be clicked on, scrolled around in or paged through, etc. This is however, only one possible interface, and there are many other possibilities that may be embraced within the spirit of this invention.

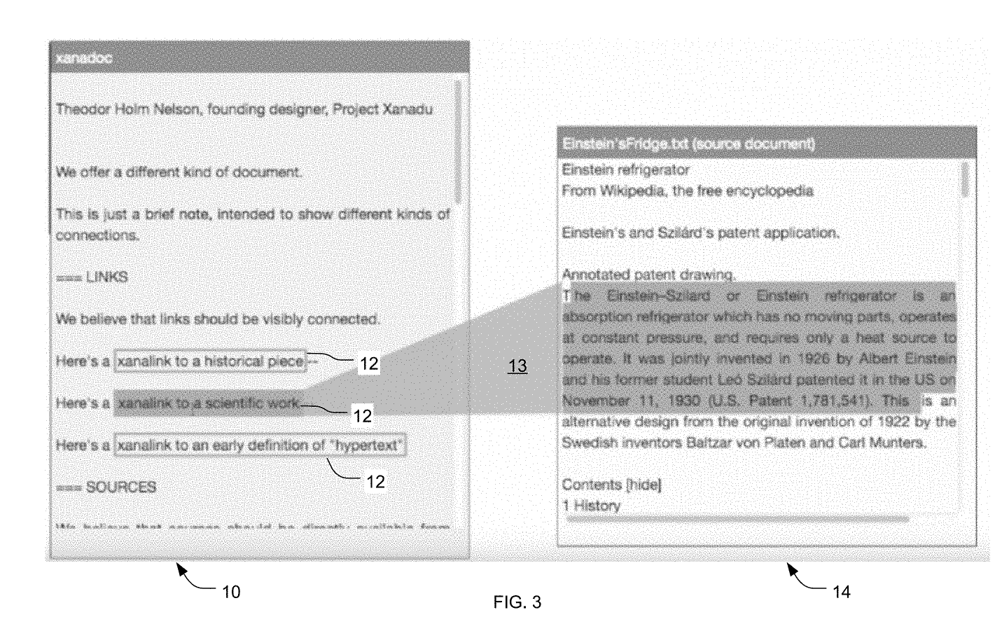

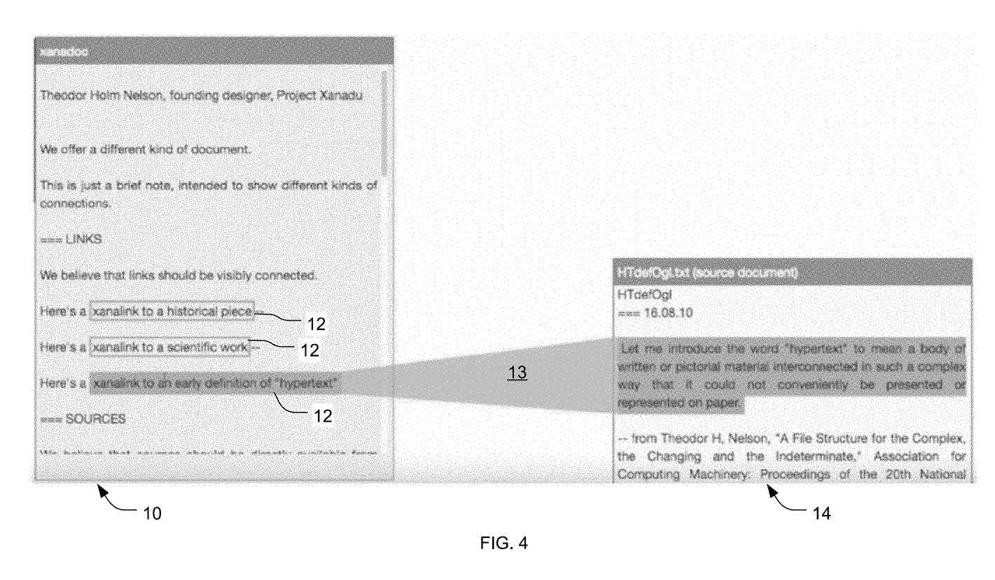

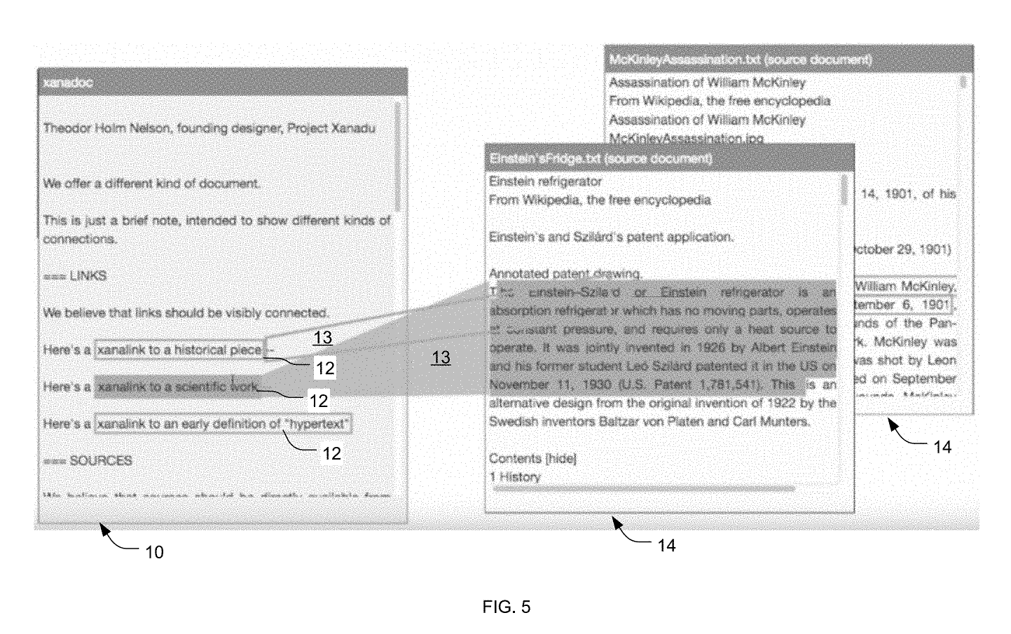

FIG. 2 depicts an activated xanalink 12, from the xanadoc 10 to a portion of a historical document (other content 14); FIG. 3 depicts an activated xanalink 12, from the xanadoc 10 to a portion of a scientific document (other content 14); FIG. 4 depicts an activated xanalink 12, from the xanadoc 10 to a portion of a topical document (other content 14) and FIG. 5 depicts the xanalinks 12 to both the historical and scientific documents activated, to illustrate that multiple xanalinks 12 and instances of other content 14 can be worked with concurrently. Note, for simplicity in conveying the concepts here, the other content 14 in these examples are only small portions, but they could just as easily be larger portions, say, multiple pages long, or even the entire content of an instance of other content 14. Note also, instances of other content 14 that are documents have been used here to convey basic concepts. There is a broad range in the possible nature of the other content 14. For example, rather than a document, other content 14 might be audio or video in nature.

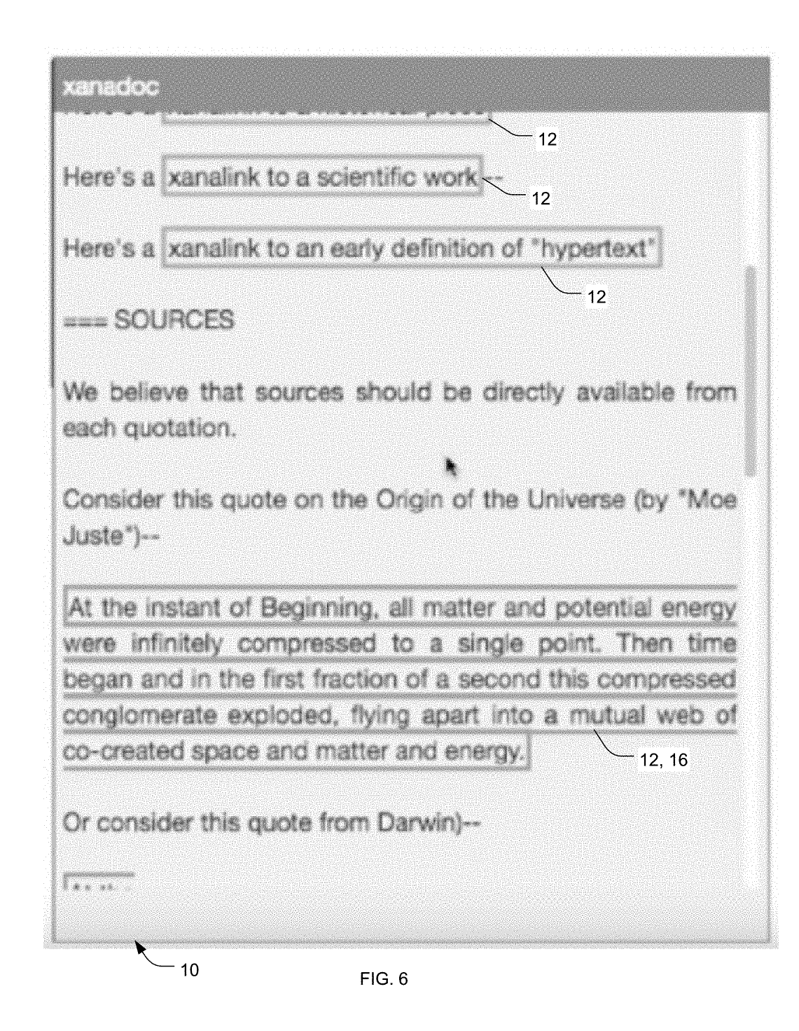

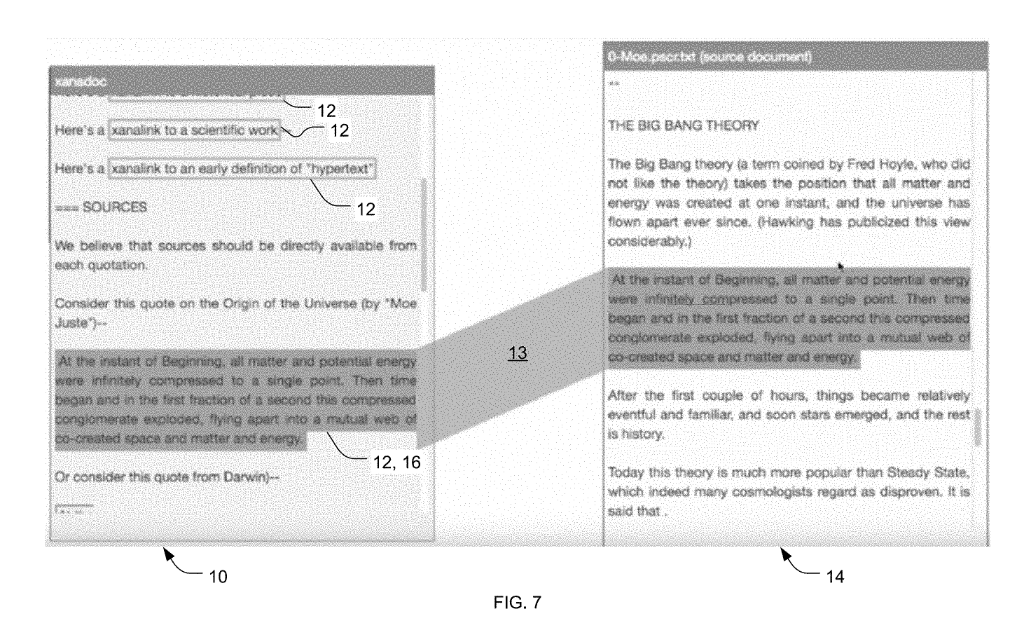

FIGS. 1-5 have depicted a simple xanadoc 10 and simple xanalinks 12. While xanalinks 12 can certainly be used in this manner, a more powerful ability is to use a xanalink 12 in a manner that superficially resembles a quotation. FIGS. 6-7 show an example of a xanalink 12 that is a “live quote” (a term that has undue document-centric connotations) or, as the inventor prefers to term these, a “transclusion” (transclusion 16). FIG. 6 shows how the xanadoc 10 appears to a reader before the transclusion 16 is activated, and FIG. 7 shows what happens when the transclusion 16 is activated and the visible bridge 13 and the other content 14 appear. As can be seen in FIG. 6 the transclusion 16 superficially resembles a quotation, but as FIG. 7 reveals the transclusion 16 is actually something far more powerful and useful. Again, if a reader wants to see the original context of a transclusion 16 or to read further beyond the current quotation, that is, view more of the other content 14, they can click on the other content 14 and scroll, page, etc, through it.

How is this all done? It is simple, a xanadoc 10 is not a lump file. It is delivered as a list of pointers to contents, which a computerized machine sends for, processes, and fulfills as a presentation on a display screen. For example, let us close this xanadoc 10 and look at the list behind it, an Edit Decision List (EDL; to borrow a video industry term) that tells what portions of other content 14 to bring in and what links to apply.

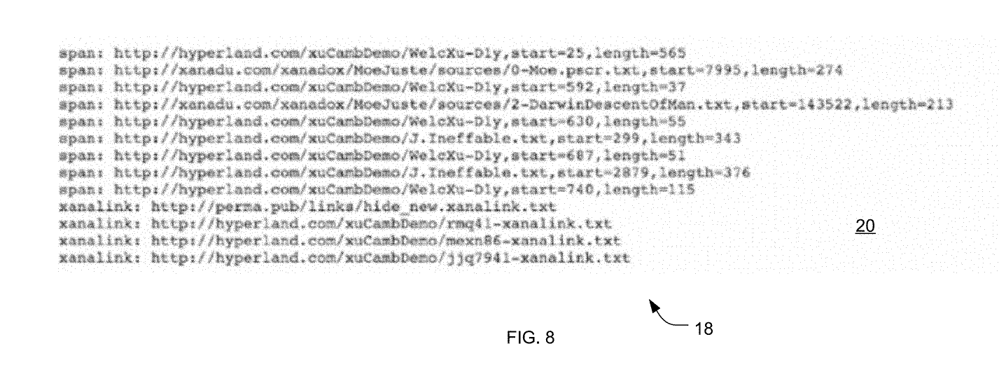

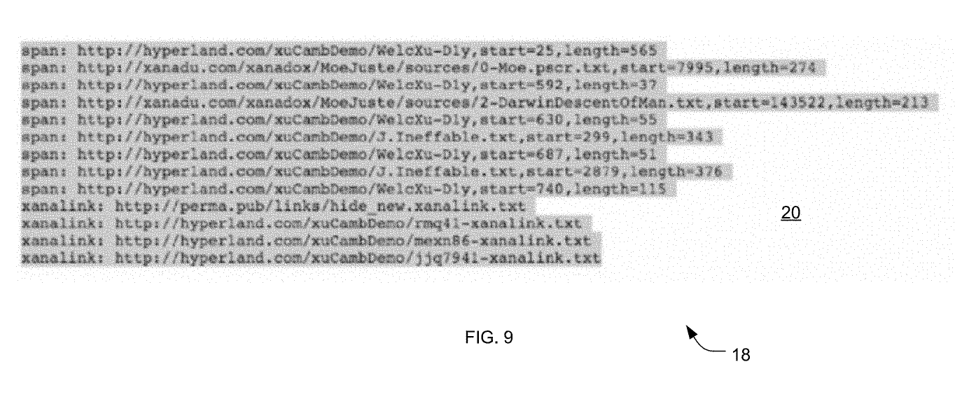

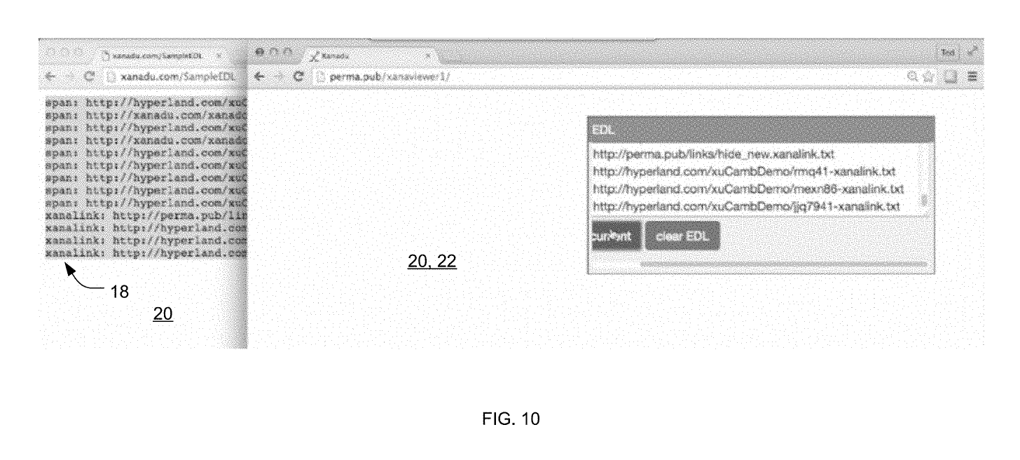

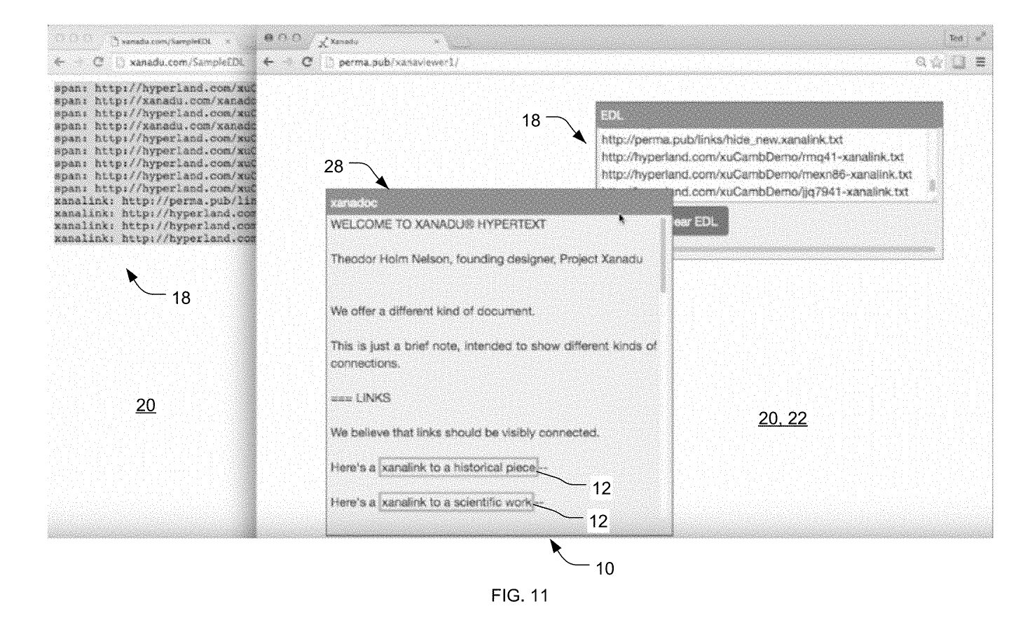

FIGS. 8-11 show an EDL 18, copying and potentially editing it in a viewer 20, and rendering it into the same or an edited xanadoc 10. FIG. 8 shows the content of the EDL 18. FIG. 9 shows some, here all, of the list content being selected and copied (e.g., into a computer “clipboard”). FIG. 10 shows the copied list content being pasted into the viewer 20. A dedicated viewer can be created for this. Alternately, the inventor has created a “xanaviewer” and put it online at xanadu.com, where one can access it (xanaviewer 22). FIG. 11 shows how the resulting xanadoc 10 appears in the xanaviewer 22.

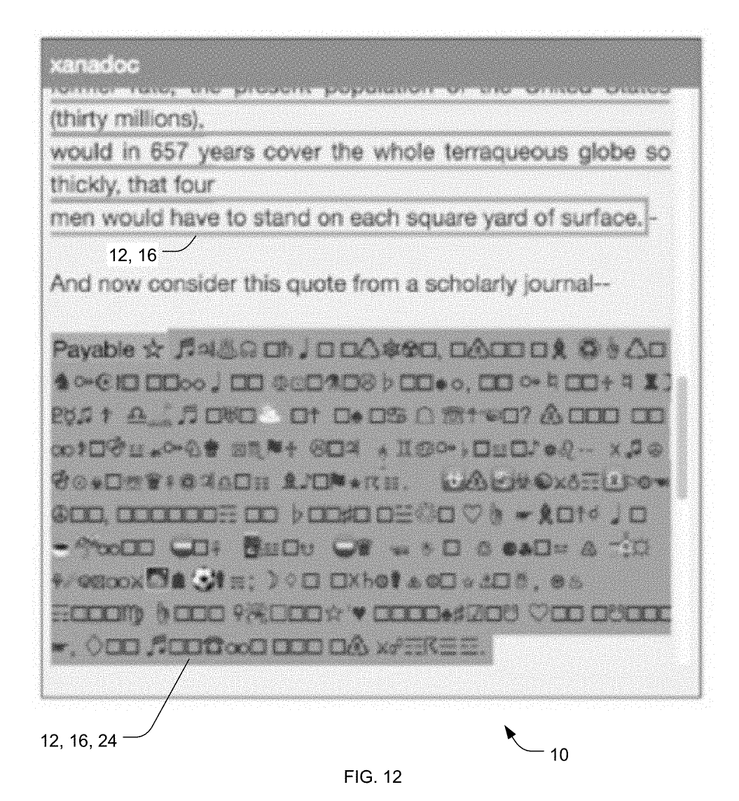

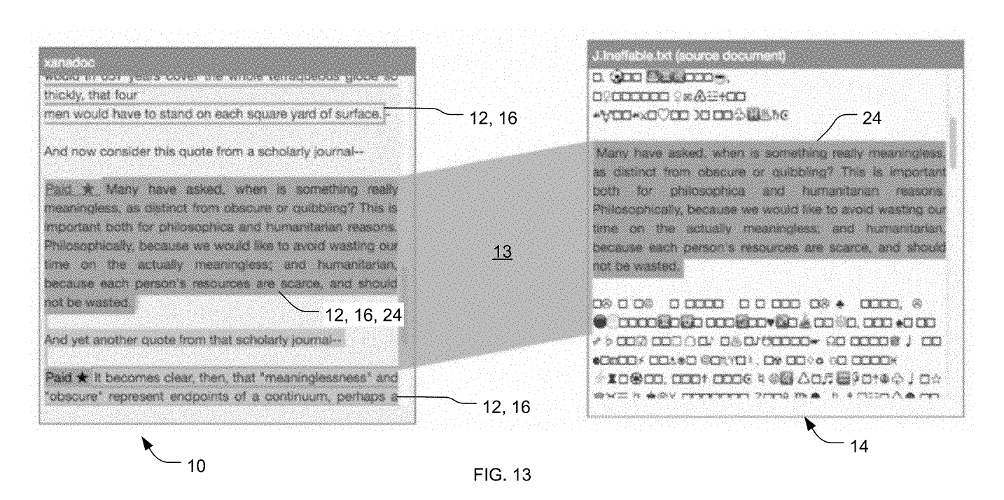

Continuing with the example xanadoc 10 we have been using, FIG. 12 stylistically shows a block portion that appears if we scroll down below what we previously viewed. What is the block portion of odd looking characters here? It is a span 24 of the other content that has not been paid for, from an academic journal who's owner wants payment. For the sake of example, which will become clear in FIG. 13, the example xanadoc 10 includes the span 24 which is visible in FIG. 12 and also has a second portion from the same academic journal, that is further along in the xanadoc 10.

If the xanadoc 10 is being viewed in the xanaviewer 22, or another suitably programmed system, the system can see, that the journal's owner has set an acceptably low price. The system can therefore automatically, based on preset criteria, or with one click buy the desired journal content and bring in the two desired portions of it.

FIG. 13 shows the example of FIG. 12 with the transclusions 16 resolved into usable spans 24. For example, the two desired portions, totaling 458 characters, can cost 73,200,000 nanobucks (a hypothetical eCurrency), or just over 7 cents (in conventional currency). That is reasonable pricing for content from an academic journal.

FIG. 13 further shows one transclusion 16 activated and connected to the other content 14 (the academic journal) via a visible bridge 13. Notice that the other content 14 that does not correspond with any transclusions 16 stylistically appears here as odd looking characters, depicting that it is royalty content that has not been paid for and is not usable. However, if the owner of the academic journal is willing, such royalty content from the journal may be bought by the character. Thus, a special advantage here is that if one wants to read more of the journal article, or to see its original context, one can go right to it, scroll up or down, etc., paying tiny amounts as they go (a la cart), or simply buying the whole article, say, for 52 cents. This is much more reasonable than the high prices many academic journals are trying to charge today, and the reason that many are now floundering. The inventor appreciates that academic journals serve a desirable good, and urges that the present invention will help save them.

Of course providers still get to set their prices, and readers get to approve their purchases. Sale is by individual character, as fine-grain as one can get. Ten million nanobucks can be set equal to one cent, for instance, thus permitting a very wide range of pricing. And what is the copyright solution? This invention permits a completely different copyright doctrine—the transcopyright permission, for content distributed as lists, with new rights and possibilities.

People may ask, what is wrong with Creative Commons? It is well-intentioned, but it is for Lump Files—and it is mainly a way that people give up hope of payment. This invention permits restoring that hope, on a reasonable basis.

Another main question people may ask is how do you keep the connected content from changing? The answer is simple, it cannot. The content has to be stabilized, by storing it in a permanent form. This is a political problem more than a technical one, because of the rights issues.

Okay, that is it! Feel free to use xanadocs now. One can create and distribute their own xanadocs, and see them in a browser at xanadu.com (or program their own viewer).

The inventor is working on a better editor; meanwhile, one can select portions or spans of content in files of other content 14 for an edit decision list (EDL 18) with the xanaviewer 22 at xanadu.com. The interface can be anything. Unlike Microsoft Word™, for instance, which gives us one column and a cursor, a very basic approach, the interface becomes the main problem once the vast possibilities of this structure are you understood. Right now the xanaviewer 22 only works with text, but of course it can be extended it to other media, including connection to Web pages. If you want to try a fine-grain payment system, the inventor has provided a demonstration royalty server for publishing content at royalty.pub. Of course “play money” is used now, so one's first ten billion nanobucks are free. This royalty server, too, only works with text at the moment, but expanding it to pictures, audio and video is an important next step. And there is much more possible.

### Creating and Publishing Xanadocs with the Xanaviewer

It is now possible (but not yet easy) for anyone who is determined enough to create a xanadoc 10, and send it to others, who may open and use it. [Remember that the World Wide Web was available for several years before the Mosaic editor made it easy for the public.]

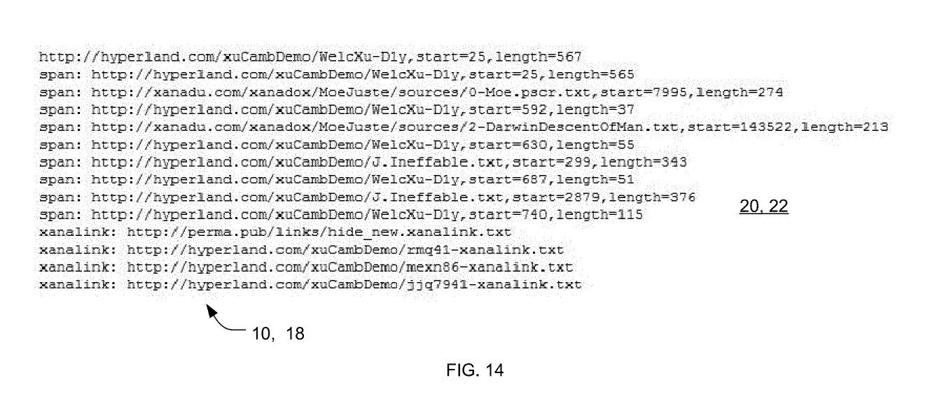

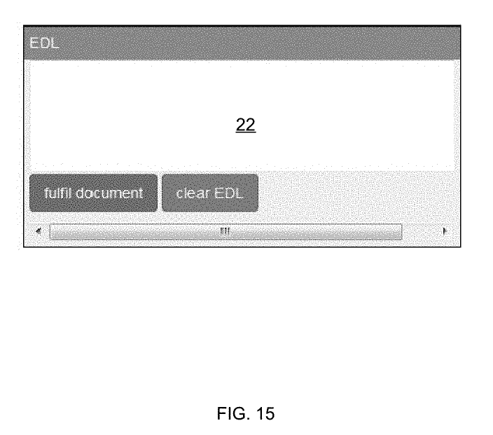

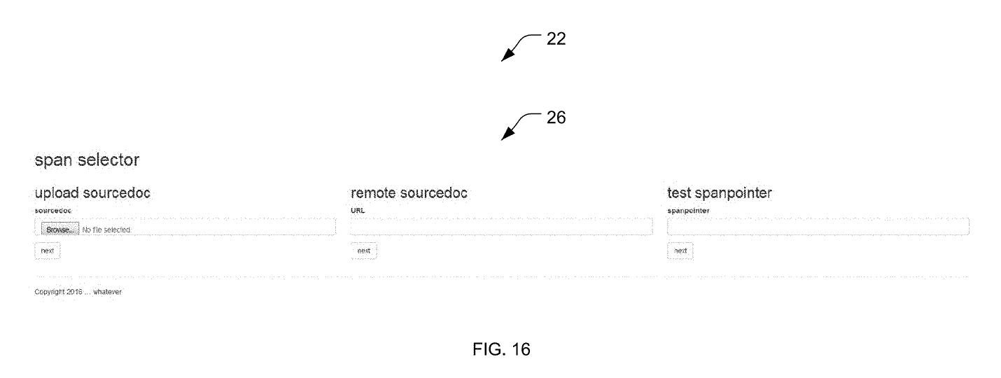

The xanaviewer 22 is still a work-in-progress and size-limited. Nonetheless, it works with a sample xanadoc 10 one can put in the xanaviewer 22 (FIG. 14 shows a sample xanadoc 10 in the xanaviewer 22 as an EDL 18). It serves as a viewer for the xanadoc 10 (FIG. 15 shows the editing window for EDLs 18 in the xanaviewer 22, which is suitable for viewing and editing the xanadoc 10). The xanaviewer 22 also serves as a place to measure spans 24 of the other content 14 (FIG. 16 shows a sample span selector 26 to select and measure spans 24).

### Current Restrictions of the Xanaviewer

The current prototype xanaviewer 22 (see e.g., FIG. 16 only works from text data already on the net and cannot work with large files yet.

### What One Can Do Now with the Sample Xanadoc

Open the page with the sample xanadoc 10 as an EDL 18 (see e.g., FIG. 14). Paste the contents of that page (the sample xanadoc 10) into the EDL editor window of the xanaviewer 22 (see e.g., FIG. 15). Click the “fulfill document” button. Then wait. A new page 28 will open (see e.g., FIG. 11) that shows the xanadoc 10 as a document. Now, when one clicks on a xanalink 12 or a transclusion 16 a visible bridge 13 will appear and an instance of the other content 14 will open (or close, second click).

### Making Your Own Xanadoc

Currently xanadocs 10 may only be built from text data already on the net. Anything you wish to transclude (“live-quote”) must also currently be in a textfile on the net.

### 1. Putting Content into Your Xanadoc

Using the span selector 26 (FIG. 16), select content spans 24 from existing textfiles on the net (instances of other content 14) that you want to bring into your xanadoc 10. If one wants to write new content, first put it on the net as a textfile and then select from it with the span selector 26.

### 2. Putting Links in Your Xanadoc

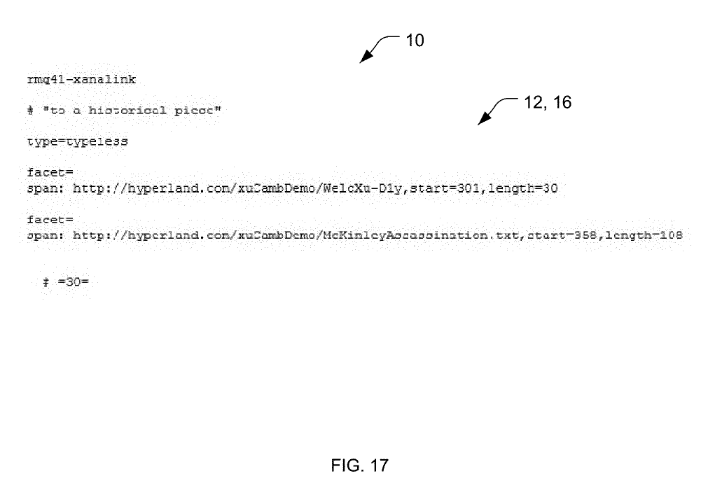

The spans 24 in a xanadoc 10 can be linked to existing text type spans 24 on the net, to sourcedocs on the net, or other xanadocs 10 on the net. (Try modifying sample a xanalink 12 from the demonstration xanadoc 10 at xanadu.com. FIG. 17 shows modifying such a sample xanadoc 10.) The xanalinks 12 created must then be put on the net and listed in an EDL 18.

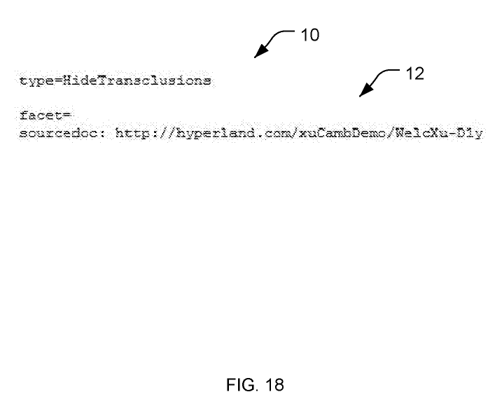

If one does not want to show specific content as inserted in a xanadoc 10 (e.g., as xanalinks 12 rather than as transclusions 16; see e.g., FIG. 1 vs. FIG. 7), FIG. 18 shows an example of modifying such a sample xanalink 12.

### 3. Publishing Your Xanadoc

The easiest way to publish a xanadoc 10 may be to email it as an EDL 18 to others, and suggest that they paste it into the xanaviewer 22. Of course, other methods can be used.

### The EDL, or Xanadoc File

The file for a xanadoc 10 need not contain any new text or media elements to be shown, since the inventor believes all media elements should be permanized and addressable.

The xanadoc 10 in your viewer is built from portions of the other content 14 brought in from elsewhere, and properties applied to that content (xanalinks 12 or transclusions 16). It is generated by a xanadoc 10 as a file, or an EDL 18 that tells a client machine what portions of content to bring in, and how to assemble and connect them.

An EDL 18 contains two types of elements: The first are the spans 24, portions of instances of other content 14 to bring in (currently only from textfiles on the net). The second are the xanalinks 12 (wherein transclusions 16 are a specialized type of xanalink 12), tables saying what to connect, etc.

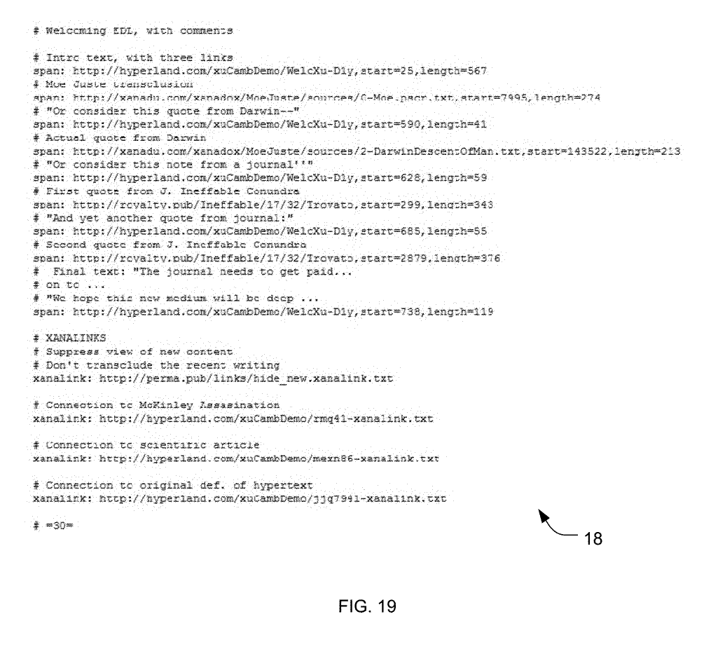

At least two formats of an EDL 18 can be employed. FIG. 14 shows a minimal EDL 18 and FIG. 19 shows an EDL 18 with extensive comments.

### Xanalinks

As the inventor prefers, a xanalink 12 is not embedded or hierarchical, like links in HTML. Rather, a xanalink 12 is a free-standing table identifying or relating content, telling the client machine what relations, properties, structures, connections, assemblies, and arrangements to apply to that content. A xanalink 12 can connect one or many spans 24, pages or documents.

There are many types of xanalink 12 that are possible. Overall, however, a xanalink 12 is a table of one or more connections. For many reasons a xanalink 12 may be a separate file (e.g., envision the respective contents of FIGS. 17 and 18 simply stored as individual files). For instance, this facilitates the same xanalink 12 being used as a “building block” in more than one EDL 18, while retaining its original identity. The xanalinks 12 can also have facets, or connections with specific meanings (not shown).

While various embodiments have been described above, it should be understood that they have been presented by way of example only, and that the breadth and scope of the invention should not be limited by any of the above described exemplary embodiments.

What is claimed is:

1. A method for document management by a user of a computerized system having a display screen, the method comprising the steps of:
providing a document that appears as plain text on the display screen;
providing within said document a connection, wherein when non-activated said connection appears as said plain text on the display screen;
selecting said connection by the user of the computerized system, to thereby activate said connection, wherein said connection then appears on the display screen as said plain text along with an open visible bridge that connects to an open other content.

2. The method of claim 1, wherein:
said connection, when non-activated, appears as said plain text that describes said other content; and
said connection, when activated, appears as said plain text that describes a portion of said other content as demarcated by said open visible bridge.

3. The method of claim 1, wherein:
said connection, when non-activated, appears as said plain text that resembles a quotation of said other content; and
said connection, when activated, appears as said plain text that resembles a quotation of said other content as demarcated by said open visible bridge.

4. The method of claim 1, further comprising:
when said connection is activated and said open other content appears selecting within said open other content by the user permits navigation within said open other content.

5. The method of claim 1, wherein:
said document is reproducible from an edit decision list.

6. The method of claim 5, wherein:
said edit decision list directs the computerized system to send for, process, and fulfill the document as a new presentation on the display screen.

7. The method of claim 1, further comprising:
said connection, when non-activated, appears as said plain text that resembles a placeholder for a quotation of said other content;
said connection, when activated, permits purchase of a portion of said other content; and
said connection, if said purchase is consummated, appears as said plain text that resembles a quotation of said portion of said other content as demarcated by said open visible bridge.

8. The method of claim 7, wherein:
said purchase is consummated automatically based on criteria preset by the user.

9. The method of claim 7, wherein:
said purchase is consummated manually by the user paying for said purchase.

10. The method of claim 7, wherein:
said other content is a published document and said purchase of said portion is of a quantity of characters in said published document.

11. The method of claim 7, wherein:
said purchase is handled via a royalty server.

12. The method of claim 7, wherein:
said document includes a plurality of said connections that describe respective said portions in a plurality of said other content that are a mixing of free and paid content.
